(19) United States
(12) Patent Application Publication
(10) Pub. No.: US 2018/0286576 A1
(43) Pub. Date: Oct. 4, 2018

(54) PANCAKE COILS FOR WIRELESS ENERGY TRANSMISSION TO ELECTRIC VEHICLES

(71) Applicant: Franz Eiermann, Rattelsdorf-Ebing (DE)

(72) Inventor: Franz Eiermann, Rattelsdorf-Ebing (DE)

(21) Appl. No.: 15/555,110

(22) PCT Filed: Feb. 19, 2016
(86) PCT No.: PCT/EP2016/053517

§ 371 Date: Jun. 12, 2018

(30) Foreign Application Priority Data
Mar. 3, 2015 (DE) 10 2015 203 796.7

(51) Int. Cl. H01F 38/14; H02J 50/10; H01F 27/28; H02J 50/70; B60L 11/18

(52) U.S. Cl. CPC H01F 38/14; H02J 50/10; B60L 11/182; H02J 50/70; H01F 27/2871

(57) ABSTRACT

An apparatus and system for wireless energy transmission to an electric vehicle are provided. A charging station and/or an electric vehicle that is configured with a pancake coil are also provided.

### CROSS REFERENCE TO RELATED APPLICATIONS

This present patent document is a § 371 nationalization of PCT Application Serial Number PCT/EP2016/053517, filed Feb. 19, 2016, designating the United States, which is hereby incorporated in its entirety by reference. This patent document also claims the benefit of DE 102015203796.7, filed on Mar. 3, 2015, which is also hereby incorporated in its entirety by reference.

### FIELD

Embodiments relate to pancake coils for wireless energy transmission to electric vehicles.

### BACKGROUND

The use of electric vehicles is known. Electric vehicles, if not independently supplied with electrical energy, for example, by solar cells, are frequently provided with an energy accumulator that requires recharging on a regular basis.

Electric vehicles for use in road traffic are connected to a charging station by a connection between a plug-in connector and an appropriate socket. Stations are provided with corresponding cables.

These stations or cables are exposed to adverse weather conditions, and are also subject to other external factors that may contribute to the impairment of operation.

The connection of plug and socket is to be completed manually in order for charging to occur, possibly resulting in further damage.

Energy transmission by coils is also known.

### SUMMARY AND DESCRIPTION

The scope of the present invention is defined solely by the appended claims and is not affected to any degree by the statements within this summary. The present embodiments may obviate one or more of the drawbacks or limitations in the related art.

Embodiments provide a pancake coil for wireless energy transmission to an electric vehicle.

Embodiments provide for automation of the charging process, as the electric vehicle only needs to be brought into the vicinity of the charging coil in an appropriate manner. The employment of autonomous electric vehicles, of the type known in industrial or automation engineering applications, is supported accordingly. The disadvantages of electric vehicles and charging devices for use in road traffic are also eliminated.

The use of pancake coils is characterized in that the pancake coils have a compact and simultaneously flat configuration. The individual coils have a high quality that increases the efficiency of energy transmission. Both of these characteristics, inter alia, are delivered by the configuration of pancake coils that include two-layer spiral coils of litz wire wound in the same direction. A first coil, in a first layer, is wound from the outside inwards, and a second coil, in a second layer, is wound from the inside outwards.

For the use of the pancake coil, layers of the first coil are arranged so as to be dielectrically separated.

In an embodiment, for the use for the dielectrically separated arrangement of the first coil, at least one, specifically thin plate g, formed of FR4 or derivatives of FR4, is interposed between the layers. The arraignment includes stable seating of the coils and also an optimization of the energy transmission function. Derivatives are defined herein as bonding materials that are configured for use as a printed circuit board material.

Alternatively or additionally, for the dielectrically separated arrangement of the first coil, a Teflon film is interposed between the layers. The Teflon film saves space and provides further degrees of freedom for the optimization of the energy transmission function, by the corresponding dimensioning thereof.

In an embodiment, for the dielectrically separated arrangement of the first coil, at least one coat of lacquer is applied between the layers. The at least one coat of lacquer provides a further space saving option or degrees of freedom for the optimization of the energy transmission function.

In an embodiment, the pancake coil is arranged on a ferrite assembly (e.g., configured in the form of a plate). The ferrite assembly is structured as a plate. The inductance is thus increased, and the winding volume is minimized accordingly. A ferrite base of this type drives the (electro)magnetic field into the field of the other half-space of the field, or restricts the (electro)magnetic field to a total of one half-space.

In an embodiment, an assembly for wireless energy transmission to an electric vehicle is provided. A charging station and/or electric vehicle is configured with a pancake coil described for the above-described uses.

### BRIEF DESCRIPTION OF THE FIGURES

FIG. 1A depicts an overhead view of a first layer according to an embodiment.

FIG. 1B depicts a side view of the pancake coil to be used for energy transmission according to an embodiment.

### DETAILED DESCRIPTION

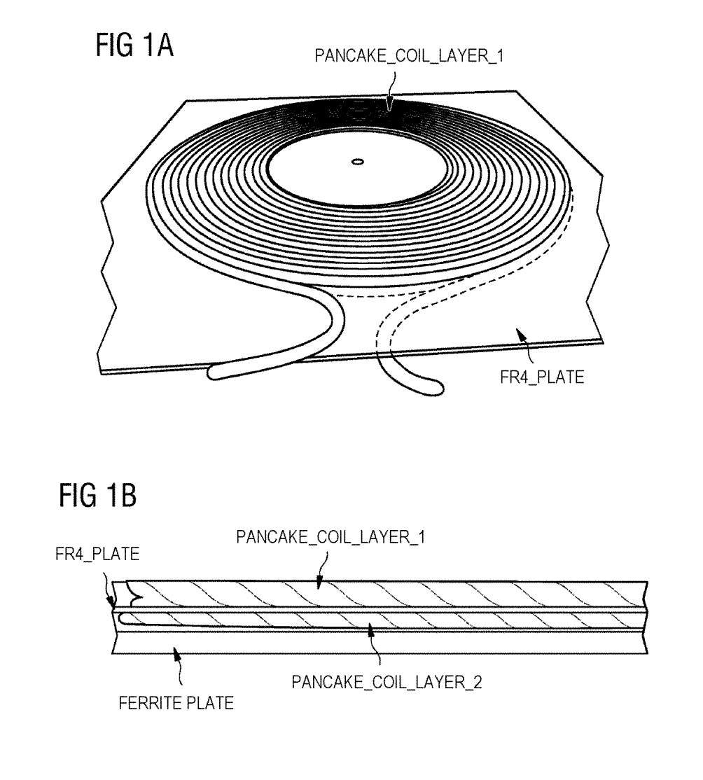

The embodiments depicted in FIGS. 1A and 1B of the pancake coil provide for the inductive charging of vehicles (or the batteries thereof). The embodiments provide that the power transmission coils, or the transformer system formed by arrangement of two such coils (e.g., one in the vehicle and one in a charging station) are configured for the lowest possible losses.

In an embodiment, a coil system with individual coils of the highest possible quality, which may be constituted by the use of pancake coils, is provided.

The size of the individual coils may be of as compact and flat a design as possible.

In the example depicted, the coil system is configured on a ferrite surface that provides that the electromagnetic field distribution is limited to a single half-space, and the inductance value of the pancake coil is increased. Alternatively, the winding volume is reduced accordingly.

One or more of the present embodiments are thus clearly distinguished from the use of single-layer spiral coils, or combinations thereof such as, for example, arrangements of the “butterfly” type.

The use of pancake coils, as depicted in FIG. 1A (overhead view) and FIG. 1B (side view), fulfills the configuration discussed above. In the Figures, the coils PANCAKE_COIL_LAYER_1 and PANCAKE_COIL_LAYER_2 are depicted. The pancake coils are configured as two-layer spiral coils of litz wire, with the same direction of winding. The first coil PANCAKE_COIL_LAYER_1, in the first layer, is wound from the outside inwards, and the second coil PANCAKE_COIL_LAYER_2, in the second layer, is wound from the inside outwards.

In an embodiment, the dielectric separation of the two layers is achieved by a thin bonding material plate (e.g., a FR4 plate FR_4_PLATE). Alternatives or additions include Teflon film or lacquer. The litz wire at the end of the first winding passes through a bore in the bonding material plate FR_4_PLATE to the other layered side of the bonding material plate FR_4_PLATE.

The assembly is applied to a ferrite plate FERRITE PLATE.

In order to restrict the (electro)magnetic field distribution of the pancake coil to one half-space and increase the inductance value of the pancake coil (saving both coil windings and volume), the pancake coil is arranged on a ferrite surface that is configured, for example, as the plate FERRITE PLATE, as a star-shaped ferrite assembly or a similar ferrite assembly. The (electro)magnetic field of the other half-space of the field is driven into the ferrite surface. The influence of a metal base is negligible, or may be provided by field shielding.

In a test assembly represented in FIGS. 1A and 1B, values of L225μH and Q=1000 at a frequency f=100 kHz may be used for an inductance. Q represents the coil quality. A value of 1000 at 100 kHz, with copper as the base material and at room temperature, represents the optimum value that may be achieved at this frequency, and describes the ratio of the reactance=2*pi*f*L to a loss resistance R, thus providing a measure for coil losses.

Coil losses may be minimized.

Embodiments provide the optimum employment of the second layer, in comparison with the employment of single-layer spiral coils. The feedback of the coil wire in a single-layer coil that would be necessary makes the use of a larger coil diameter with an equal height necessary.

High-quality coils may thus be produced, with the optimum exploitation of volume.

It is to be understood that the elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent, and that such new combinations are to be understood as forming a part of the present specification.

While the present invention has been described above by reference to various embodiments, it may be understood that many changes and modifications may be made to the described embodiments. It is therefore intended that the foregoing description be regarded as illustrative rather than limiting, and that it be understood that all equivalents and/or combinations of embodiments are intended to be included in this description.

1. An apparatus for wireless energy transmission to an electric vehicle, the apparatus comprising:
at least a first coil for wireless transmission to the electric vehicle, the first coil configured as a pancake coil,
wherein the pancake coil is arranged on a ferrite structure configured in the form of a plate, such that the pancake coil is only enclosed by the ferrite structure on one side, and the pancake coil is configured as a spiral coil having at least two layers such that a first layer of the at least two layers is arranged so as to be wound from an outside inwards, and a second layer of the at least two layers is arranged so as to be wound from an inside outwards.

2. The apparatus of claim 1, wherein layers of the at least two layers are arranged so as to be dielectrically separated.

3. The apparatus of claim 2, wherein for the dielectrically separated arrangement of the at least two layer spiral coil, a thin plate formed of FR4 or derivatives of FR4 is interposed between the layers.

4. The apparatus of claim 2, wherein for the dielectrically separated arrangement of the at least two layer spiral coil, a Teflon film is interposed between the layers.

5. The apparatus of claim 2, wherein for the dielectrically separated arrangement of the at least two layer spiral coil, at least one coat of lacquer is applied between the layers.

6. (canceled)

7. A system for wireless energy transmission, the system comprising:
a charging station comprising a first pancake coil for transmission to an electric vehicle, the electric vehicle comprising a second pancake coil for transmission to the charging station, or the charging station comprising the first pancake coil and the electric vehicle comprising the second pancake coil,
wherein the first pancake coil, the second pancake coil, or each pancake coil of the first pancake coil and the second pancake coil is arranged on a respective ferrite structure configured in the form of a plate, such that the respective pancake coil is only enclosed by the respective ferrite structure on one side, and the respective pancake coil is configured as a spiral coil having at least two layers such that a first layer of the at least two layers is arranged so as to be wound from an outside inwards, and a second layer of the at least two layers is arranged so as to be wound from an inside outwards.

8. The system of claim 7, wherein layers of the at least two layer spiral coil are configured to be dielectrically separated.

9. The system of claim 8, wherein for the dielectrically separated arrangement of the at least two layer spiral coil, a thin plate formed of FR4 or derivaties of FR4 is interposed between the layers.

10. The system of claim 8, wherein for the dielectrically separated arrangement of the at least two layer spiral coil, a Teflon film is interposed between the layers.

11. The system of claim 8, wherein for the dielectrically separated arrangement of the at least two layer spiral coil, at least one coat of lacquer is applied between the layers.

12. A method for using a pancake coil for wireless energy transmission to an electric vehicle, the method comprising:
wirelessly transmitting, by a pancake coil, energy to the electric vehicle, the pancake coil arranged on a ferrite structure configured in the form of a plate, such that the pancake coil is only enclosed by the ferrite structure on one side, and the pancake coil is configured as a spiral coil having at least two layers such that a first layer of the at least two layers is arranged so as to be wound from an outside inwards, and a second layer of the at least two layers is arranged so as to be wound from an inside outwards.
